(19) United States
(12) Patent Application Publication
(10) Pub. No.: US 2015/0068482 A1
(43) Pub. Date: Mar. 12, 2015

(54) KINETIC SYSTEM-ORIENTED VARIABLE INTAKE STRUCTURE

(71) Applicant: MOTIVE POWER INDUSTRY CO., LTD., Dacun Township (TW)

(72) Inventor: TAI-CHUN CHEN, DACUN TOWNSHIP (TW)

(73) Assignee: MOTIVE POWER INDUSTRY CO., LTD., Dacun Township (TW)

(21) Appl. No.: 14/021,066

(22) Filed: Sep. 9, 2013

(51) Int. Cl. F02M 35/10

(52) U.S. Cl. CPC F02M 35/10091
USPC 123/184.53

(57) ABSTRACT

A kinetic system-oriented variable intake structure includes an intake passage, an air storing space, an exhaust passage, a control valve, and a bypass air chamber. The intake passage and the exhaust passage are in communication with the air storing space to allow air to enter the air storing space via the intake passage and then be discharged from the exhaust passage. The bypass air chamber is in communication with the air storing space through the control valve. The control valve turns on or off in accordance with a rotation speed of the kinetic system. Accordingly, the kinetic system-oriented variable intake structure is capable of high performance at any target rotation speeds.

### FIELD OF TECHNOLOGY

The present invention relates to variable intake structures, and more particularly, to a kinetic system-oriented variable intake structure capable of high performance at any target rotation speeds.

### BACKGROUND

Air flows within an intake pipe of an engine by pulsating, and the resultant pressure wave travels along a passage of the intake pipe. The pressure wave is of a wavelength which depends on the pulsating frequency, air flow rate or flow speed. As soon as the pressure wave reaches the terminal end of the passage or comes cross any obstacle within the passage, the pressure wave produces a reflection wave which propagates along the passage reversely. As a result, the resultant pressure wave consists of the principal pressure wave and the reflection wave. The principal pressure wave and the reflection wave either strengthen or offset each other, depending on their input phase or output phase.

If the intake pipe passage length and flow rate are of values which cause the pressure wave to strengthen at an inlet valve, the pressure wave will increase the flow rate of the air entering a cylinder. The increase in the air entering the cylinder enhances the volumetric efficiency thereof However, in case of a phase difference between the reflection wave and the principal pressure wave, the pressure for driving air into the cylinder will decrease slightly, so will the volumetric efficiency thereof. All early engines and most later engines are based on a passive length intake passage system whose passage length is designed in accordance with a specific flow rate and pulsation timing, that is, being applicable to only a specific speed. When it comes to other rotation speeds, the intake system is not only confronted with difficulty in the adjustment of its operation, but is also flawed with low volumetric efficiency at high rotation speeds and low rotation speeds; as a result, the intake system hardly has any industrial applicability.

### SUMMARY

It is an objective of the present invention to provide a kinetic system-oriented variable intake structure capable of high performance at any different rotation speeds.

In order to achieve the above and other objectives, the present invention provides a kinetic system-oriented variable intake structure, comprising: an intake passage; an exhaust passage; an air storing space communicating with the intake passage and the exhaust passage; a control valve turning on and off in accordance with a rotation speed of an engine; and a bypass air chamber in communication with the air storing space through the control valve.

### BRIEF DESCRIPTION

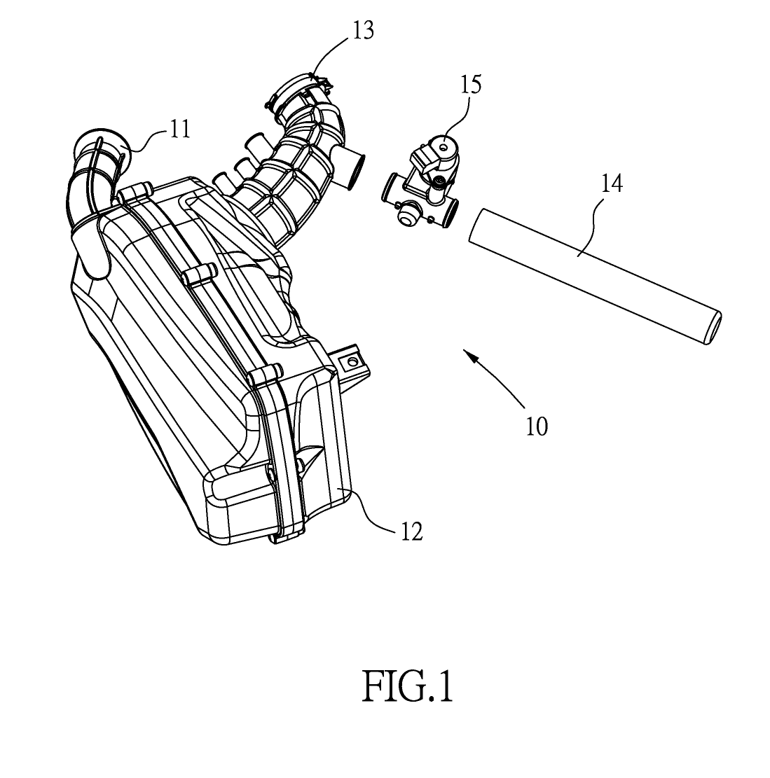

FIG. 1 is an exploded view of kinetic system-oriented variable intake structure according to an embodiment of the present invention;

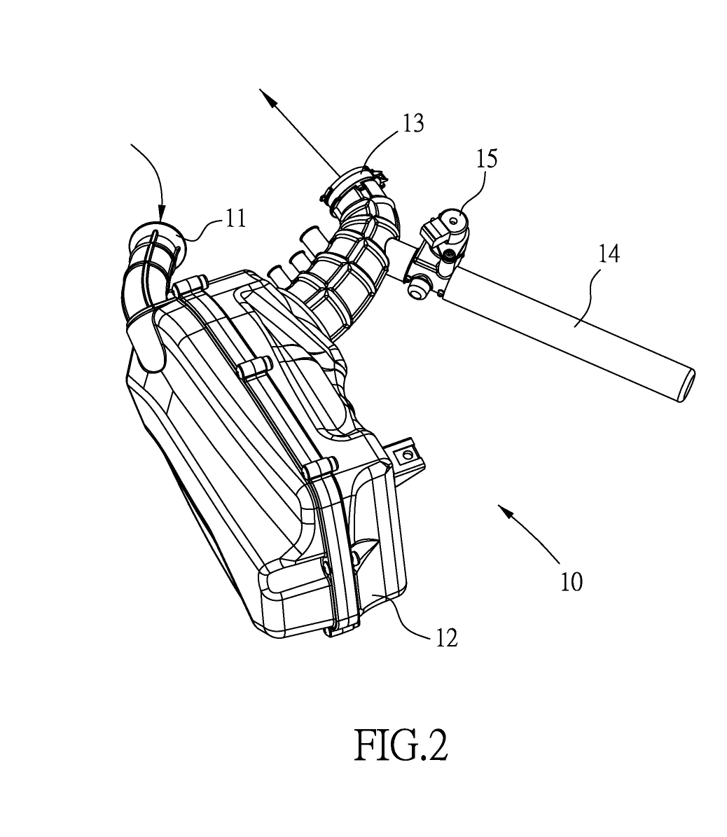

FIG. 2 is a schematic perspective view of kinetic system-oriented variable intake structure assembled according to the embodiment of the present invention;

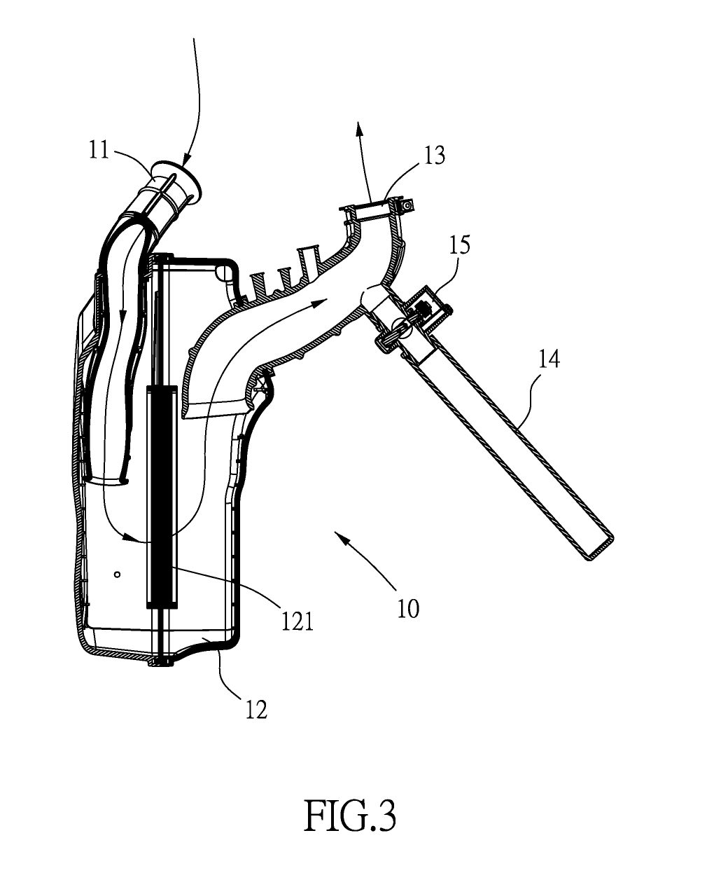

FIG. 3 is a schematic view of air current of kinetic system-oriented variable intake structure according to the embodiment of the present invention; and

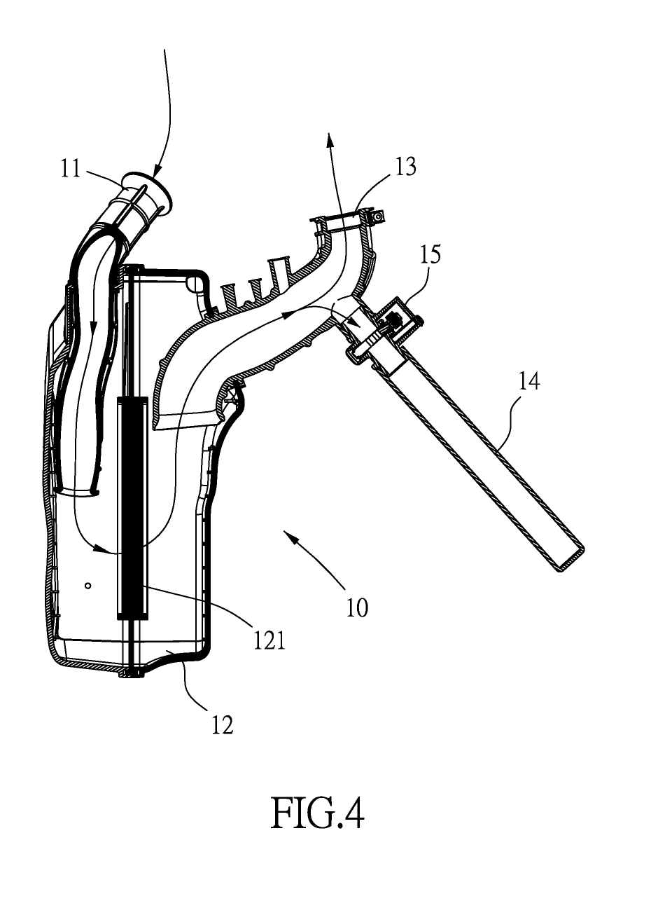

FIG. 4 is a schematic view of air current of kinetic system-oriented variable intake structure according to the embodiment of the present invention.

### DETAILED DESCRIPTION

Referring to FIG. 1 and FIG. 2, there are shown an exploded view and a perspective view of a kinetic system-oriented variable intake structure 10 according to an embodiment of the present invention, respectively. As shown in the diagrams, the kinetic system-oriented variable intake structure 10 of the present invention essentially comprises an intake passage 11, an air storing space 12, an exhaust passage 13, a control valve 15, and a bypass air chamber 14. The intake passage 11 is in communication with the exhaust passage 13 and the air storing space 12 to allow air to enter the air storing space 12 via the intake passage 11 and then exit the air storing space 12 via the exhaust passage 13, thereby producing a source of air required for generation of power by a kinetic system. Furthermore, a filter 121 is disposed in the air storing space 12 and adapted to filter impurity or dirt out of the air admitted into the intake passage 11 so as to prevent the impurity or dirt from entering into the engine and causing a failure thereof. The bypass air chamber 14 defines a closed spaced and is in communication with the air storing space 12 through the control valve 15. The control valve 15 is an electronic automated control valve which turns on or turns off according to the rotation speeds of the kinetic system.

Referring to FIG. 3 and FIG. 4, there are shown schematic views of air current of the kinetic system-oriented variable intake structure 10 according to the embodiment of the present invention, respectively. As shown in the diagrams, if the kinetic system (engine) is operating at a rotation speed (or is going to start), the control valve 15 will turn on to thereby preclude communication between the bypass air chamber 14 and the air storing space 12; as a result, the overall air storage capacity increases, which causes the intake air pressure (flow speed) to increase, thereby ensuring a certain level of output torque while the kinetic system (engine) is operating at a low rotation speed, reducing fuel consumption, and reducing exhaust. If the kinetic system (engine) operates at a high rotation speed, the control valve 15 will turn off, and the bypass air chamber 14 will be in communication with the air storing space 12, thereby decreasing the overall air storage capacity. The bypass air chamber 14 not only reduces flow resistance, but is also conducive to enhancement of intake efficiency, improvement of the combustion process, and an increase in engine horsepower.

Furthermore, engine rotation speeds for controlling the control valve 15 to turn on and turn off are adjustable according to the setting and thus are not necessarily low rotation speeds to turn on or off the control valve 15, but are adjustable as needed.

In conclusion, the kinetic system-oriented variable intake structure of the present invention is feasible for certain and solves all the drawbacks of the prior art. Hence, the present invention meets the requirements of patentability, namely novelty, non-obviousness, and industrial applicability.

The present invention is disclosed above by preferred embodiments. However, persons skilled in the art should understand that the preferred embodiments are illustrative of the present invention only, but should not be interpreted as restrictive of the scope of the present invention. Hence, all equivalent changes and modifications made to the aforesaid embodiments should fall within the scope of the present invention. Accordingly, the legal protection for the present invention should be defined by the appended claims.

1. A kinetic system-oriented variable intake structure, comprising:
an intake passage;
an exhaust passage;
an air storing space communicating with the intake passage and the exhaust passage;
a control valve turning on and off in accordance with a rotation speed of an engine; and
an air chamber in communication with the air storing space through the control valve, wherein the air chamber extends from the exhaust passage, and is directly connected to the control valve.

2. The kinetic system-oriented variable intake structure of claim 1, wherein the air storing space has a filter therein.

3. The kinetic system-oriented variable intake structure of claim 1, wherein the air chamber defines a closed space.

4. The kinetic system-oriented variable intake structure of claim 1, wherein the control valve is an electronic automated control valve.

5. The kinetic system-oriented variable intake structure of claim 1, wherein the air chamber is an elongated closed chamber.

6. The kinetic system-oriented variable intake structure of claim 1, wherein the air chamber extends directly from the exhaust passage.
